(19) United States
(12) Patent Application Publication
(10) Pub. No.: US 2008/0075945 A1
(43) Pub. Date: Mar. 27, 2008

(54) Polymer-based composite structural boards and structural systems

(76) Inventor: Duane R. Paradis, Highlands Ranch, CO (US)

Correspondence Address: JOHNS MANVILLE, 10100 WEST UTE AVENUE, PO BOX 625005, LITTLETON, CO, 80162-5005, US

(21) Appl. No.: 11/525,582

(22) Filed: Sep. 22, 2006

(51) Int. Cl. B32B 27/00

(52) U.S. Cl. 428/304.4; 442/54

(57) ABSTRACT

A polymer-based composite structural board for in-ground and above-ground use without material degradation has a polymer material or predominantly polymer material core layer with a density between 1.6 lbs/ft³ and 25 lbs/ft³. A facer overlays, is generally coextensive with, and is bonded to at least one of the major surfaces and preferably both of the major surfaces of the core layer. The facer(s) enhance the integrity and fastener pull through strength of the polymer-based composite structural board as well as other desired physical and performance characteristics of the polymer based composite structural board. The polymer-based composite board is used in foundation wall systems, utility conduit systems and other systems where the composite board is in ground contact.

### BACKGROUND OF THE INVENTION

The subject invention relates to polymer-based composite structural boards that can withstand long term contact with the ground while in service without material degradation and to building foundation and other systems that include the polymer-based composite structural boards.

For in-ground, below grade, applications where the polymer-based composite structural boards of the subject invention will be in long term contact with soil, gravel and/or other fill, the polymer-based composite structural boards of the subject invention, when compared to plywood boards, hardboards, particleboards, etc., should be able to provide advantages in installation and/or in service performance. The polymer-based composite structural boards of the subject invention can be relatively light in weight, easy to handle, and easily cut at the job site, e.g. to form a sheathing layer or a utility conduit. In addition, the polymer-based composite structural boards of the subject invention are strong and durable, absorb and retain very little moisture, are fungus growth resistant, are flame spread resistant, have relatively good thermal and acoustical properties, and have good bonding surfaces for bonding a nonstructural finish layer to a sheathing or other layer formed by the polymer-based composite structural boards.

### SUMMARY OF THE INVENTION

The polymer-based composite structural boards of the subject invention have a polymer material or predominantly polymer material core layer with a density between 1.6 lbs/ft³ and 25 lbs/ft³. The polymer-based composite structural boards of the subject invention are intended for use where the structural boards will be in long term ground contact during service, such as but not limited to exterior foundation wall sheathing and utility conduits. A facer overlays at least one of the major surfaces and preferably, facers overlay both of the major surfaces of the core layers of the polymer-based composite structural boards of the subject invention. A facer of a polymer-based composite structural board of the subject invention is generally coextensive with and bonded to the overlaid major surface of the polymer-based composite structural board and enhances the integrity and fastener pull through strength of the polymer-based composite structural sheathing board as well as other desired physical and performance characteristics of the polymer based composite structural board. In particular, the polyisocyanurate material or predominantly polyisocyanurate material polymer-based composite structural boards of the subject invention have good dimensional stability, can be relatively light in weight (especially when facers overlay both major surfaces), are easy to handle, and can be easily cut at the job site to form a foundation sheathing layer, in-ground utility conduit, etc. In addition, these polyisocyanurate material or predominantly polyisocyanurate material polymer-based composite structural boards exhibit good thermal and acoustical properties, are strong and durable, absorb and retain very little moisture, are fungus growth resistant, are flame spread resistant, and have good bonding surfaces for bonding a nonstructural finish-wall layer (e.g. paint on an interior foundation basement wall) to a wall sheathing layer formed by the polymer-based composite structural boards. With their excellent physical properties and characteristics, the polymer-based polyisocyanurate material or predominantly polyisocyanurate material composite structural boards of the subject invention are well suited for many building construction applications where the composite structural boards will be in long term below grade contact with the ground. In addition to in-ground, below grade applications, these polymer-based composite structural boards can also be utilized for above ground applications.

### BRIEF DESCRIPTION OF THE DRAWINGS

FIG. 1 is a schematic transverse cross section in elevation of a concrete foundation wall system that is partially below grade (partially below ground level) and includes the polymer-based composite structural boards of the subject invention in the wall system.

FIG. 2 is a schematic transverse cross section in elevation of a utility conduit system, which contains water lines and/or other utilities, wherein the utility conduit of the system is made wholly or in part of the polymer-based composite structural boards of the subject invention.

FIG. 3 is a fragmentary schematic perspective view of a first embodiment of the polymer-based composite structural board of the subject invention with portions broken away to better show the layers of composite.

FIG. 4 is a fragmentary schematic perspective view of a second embodiment of the polymer-based composite structural board of the subject invention with portions broken away to better show the layers of composite.

### DETAILED DESCRIPTION OF THE INVENTION

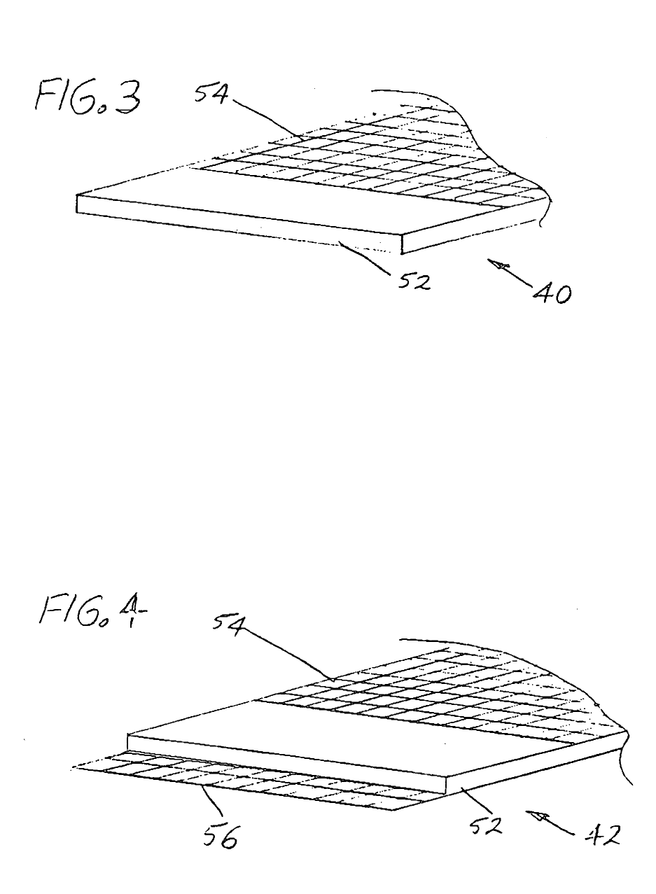

As schematically shown in FIG. 1, a foundation system 20 of the subject invention includes a concrete foundation wall 22 extending upward from a concrete slab or floor 24. The concrete foundation wall 22 is partially below and partially above ground level 18 and contained between interior and exterior form and sheathing layers 26. The interior and exterior form and sheathing layers 26 are constructed from a plurality the polymer-based composite structural boards 40 or 42 of FIGS. 3 and 4. As shown, the interior and exterior sheathing layers 26 of the foundation system 20 can serve the dual function of providing a form for making the concrete foundation wall 22 and of providing interior and exterior sheathing layers that enhance the performance of the concrete foundation wall 22 in service, e.g. by thermally insulating the wall, by providing fungus growth resistant sheathing layers, and providing a flat, uniform, good bonding surface on the interior of the wall for the application of a finish layer. Where desired, the sheathing layers 26 or portions of the sheathing layers 26 can be removed after the concrete of the foundation wall 22 sets and cures and before the excavation for the foundation system 20 is refilled with a desired fill, e.g. top soil, dirt, gravel, etc.

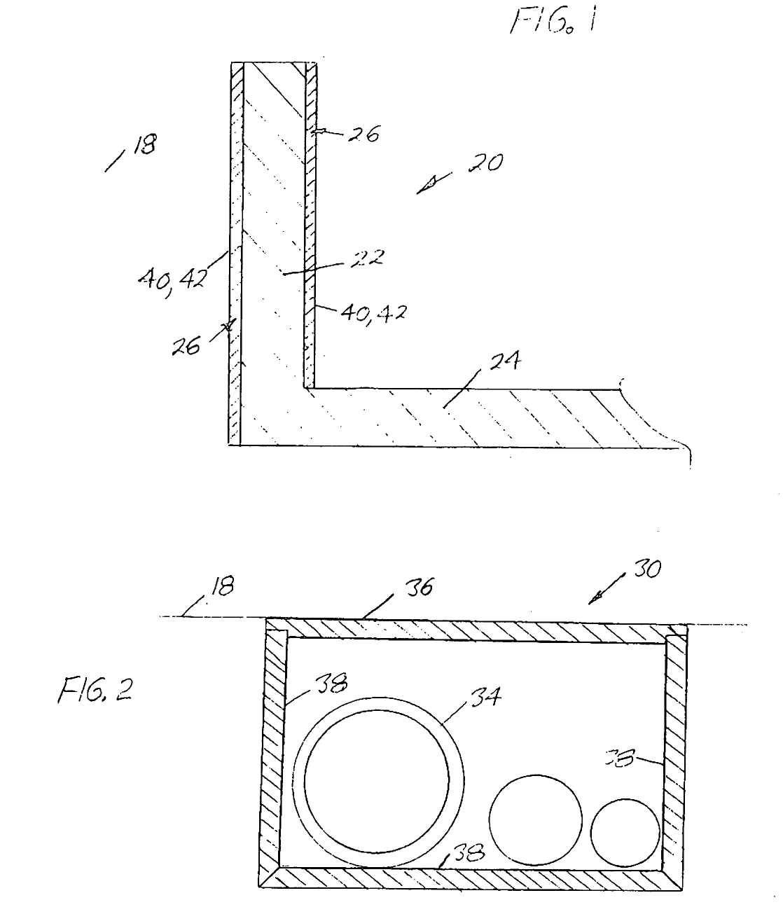

As schematically shown in FIG. 2, a utility conduit system 30 of the subject invention includes a utility conduit section 32, constructed of the polymer-based composite structural boards 40 or 42 of FIGS. 3 and 4, and utilities such as a water line 34 and/or other utilities for servicing a home, apartment complex, business, etc. that are contained within the utility conduit 32. As shown, a utility conduit section 32, which is rectangular in transverse cross section, preferably has a removable cover 36 that is constructed from a polymer-based composite structural board 40 or 42 and side and bottom walls 38 that are secured together by conventional mechanical fasteners and/or adhesives (not shown) and constructed from polymer-based composite structural boards 40 or 42. The utility conduit system 30 can include only one utility conduit section 32 or, depending on the length of the utility conduit system 30, a series of the utility conduit sections 32 that are joined together in end to end relationship by conventional mechanical fasteners and/or adhesives (not shown) to form the utility conduit system 30. Preferably, the removable cover 36 forms a shiplap or other joint with the sidewalls 38 of the utility conduit section to close, insulate, and seal off the interior of the utility conduit section 32 from external conditions while in service. Where the utility conduit system 30 is formed of a plurality of the utility conduit sections 32, some of the utility conduit sections may have a removable cover 36 while other of the utility conduit sections 32 have covers that are permanently secured to the sidewalls 38 of the utility conduit sections 32. As shown, the cover 36 of the utility conduit section 32 is at ground level 18. However, the utility conduit section 32 could be completely below ground level 18 (below grade) and totally covered fill, e.g. soil, dirt, gravel, etc. or partially above and partially below ground level 18. The utility conduit sections 32, thermally insulate the utilities within the conduit from external conditions, keep the utilities housed within the conduit sections dry, are durable, and are fungus growth resistant.

The polymer-based composite structural board 40 of FIG. 3 includes a polymer material or predominantly polymer material core layer 52 and a facer 54 coextensive with or substantially coextensive with and bonded to a first major surface of the core layer 52. The polymer-based composite structural board 42 of FIG. 4 includes a polymer material or predominantly polymer material core layer 52; a first facer 54 coextensive with or substantially coextensive with and bonded to a first major surface of the core layer 52; and a second facer 56 coextensive with or substantially coextensive with and bonded to a second major surface of the core layer 52.

The first major surface and the second major surface of the polymer or predominantly polymer material core layer 52 of the polymer-based composite structural boards 40 and 42 are each defined by the length and the width of the polymer or predominantly polymer material core layer. The polymer or predominantly polymer material core layer 52 typically has a width of about four feet or greater and a length of about four feet or greater and, preferably, a length of about eight feet.

The polymer or predominantly polymer material core layer 52 of the polymer-based composite structural boards 40 and 42 may be made of various polymer or predominantly polymer materials [e.g. a polyisocyanurate, polyurethane, polystyrene, or phenolic material or a material made of a blend of these materials; a polyisocyanurate, polyurethane, polystyrene, or phenolic foam material or a foam material made of a blend of these materials; a predominantly polyisocyanurate, polyurethane, polystyrene, or phenolic material with up to 40% by weight, but typically between about 1% and about 25% by weight organic and/or inorganic filler(s) or a material made of a blend of these materials with up to 40% by weight, but typically between about 1% and about 25% by weight organic and/or inorganic filler(s); a predominantly polyisocyanurate, polyurethane, polystyrene, or phenolic foam material with up to 40% by weight, but typically between about 1% and about 25% by weight organic and/or inorganic filler(s) or a foam material made of a blend of these materials with up to 40% by weight, but typically between about 1% and about 25% by weight organic and/or inorganic filler(s), a material made of other thermoset matrix polymers; etc.]. However, a preferred material for the core layer 52 is a polyisocyanurate material or foam material or a predominantly polyisocyanurate material or foam material with up to 40% by weight, but typically between about 1% and about 25% by weight organic and/or inorganic filler(s). Examples of various fillers that may be used in the predominantly polymer materials of the core layer 52 include but are not limited to powdered, liquid, and fiber fillers. The polymer or predominantly polymer materials of the core layer 52 may also include fiber reinforcements, fungi growth-inhibiting agents, fire-retardants, and other agents to reduce the cost of and/or modify the properties of the core layer 52, such as but not limited to the compressive strength, the toughness, the flexibility, the friability, and the fire resistance of the core layer. Examples of fillers, which may be used in the predominantly polymer material core layer 52, are fillers such as but not limited to limestone (CaCO₃), fiberglass, recycled polyisocyanurate dust, extenders/plasticizers, ground up foam insulation, ground up rubber, wood dust, etc.

The first facer 54 of the polymer-based composite structural board 40 and the first and second facers 54 and 56 of the polymer-based composite structural board 42 typically overlie the entire or substantially the entire major surface of the core layer 52 of the polymer-based composite structural board 40 or 42 to which the facer is or facers are bonded. The facers 54 and 56 of the polymer-based composite structural boards 40 and 42 may be any sheet material that provides suitable first and/or second major surfaces for the polymer-based composite structural boards 40 and 42, such as but not limited to coated or uncoated paper, foil, coated or uncoated woven or nonwoven mats made of fiberglass and/or other fibers or filaments, coated or uncoated scrims made of fiberglass and/or other fibers or filaments, etc. However, a preferred facer material for the facers 54 and 56 is an alkali resistant facer material such as but not limited to a mineral coated nonwoven fiberglass mat or fiberglass scrim wherein the coating protects the fiberglass mat or scrim from alkali degradation. Where a coated or uncoated fiberglass scrim material is used, preferably, the scrim material has a tensile strength of at least 105 lbs per linear inch, a weight of about 10 grams/ft², 8×8 strands per inch, and utilizes stands having a mean diameter of about 0.019 inches.

The polymer-based composite structural boards of the subject invention preferably have the following physical properties:

| | | Preferred Range |
|---|---|---|
| Property | Range or Minimum | or Minimum |
| Thickness | 0.15 to 2.5 inches | 0.25 to 2.0 inches |
| Density | 1.6 to 25 lbs/ft³ | 3 to 10 lbs/ft³ |
| Compressive Strength | at least 25 psi | at least 50 psi |
| Flexural Strength | | |
| Modulus of Rigidity | at least 400 psi | at least 1500 psi |
| (MOR) | | |
| Load at Yield | at least 20 lbf | at least 30 lbf |
| Fastener Pull Through | at least 20 lbf | at least 50 lbf |
| (ASTM Test D1037 - in | | |
| effect - June 2006) | | |
| Water Absorption by Volume | 4% or less | 2% or less |
| (ASTM Test C209 - in | | |
| effect - June 2006) | | |
| Thermal Conductivity | R-value of at least 1 | |
| Flame Spread Rating | at least 20 | at least 25 |
| (ASTM Test E84 - in | | |
| effect - June 2006) | | |

| | |
|---|---|
| Fungus Growth Resistance | Does Not Support Fungus Growth |

In describing the invention, certain embodiments have been used to illustrate the invention and the practices thereof. However, the invention is not limited to these specific embodiments as other embodiments and modifications within the spirit of the invention will readily occur to those skilled in the art on reading this specification. Thus, the invention is not intended to be limited to the specific embodiments disclosed, but is to be limited only by the claims appended hereto.

1. A polymer-based composite structural board for in-ground and above-ground use that can withstand long term in-ground contact with fill without material degradation while in service, comprising:
a polymer material or predominantly polymer material core layer with a density between 1.6 lbs/ft³ and 25 lbs/ft³; the core layer having a length, a width, and a thickness; the core layer having a first major surface and a second major surface that are each defined by the length and the width of the core layer; at least one of the major surfaces of the core layer being overlaid by an alkali resistant facer that reinforces and strengthens the polymer-based composite board and that is generally coextensive with and bonded to the overlaid major surface of the core layer.

2. The polymer-based composite structural board according to claim 1, wherein:
the alkali resistant facer is an alkali resistant mineral coated, nonwoven glass fiber mat or scrim

3. The polymer-based composite structural board according to claim 1, wherein:
the core layer is a predominantly polymer material core layer; the thickness of the core layer is between about 0.15 inches and about 2.5 inches; and the polymer material of the core layer is a polyisocyanurate material.

4. The polymer-based composite structural board according to claim 3, wherein:
the predominantly polymer material core layer contains between 1% and 40% by weight inorganic and/or organic filler material.

5. The polymer-based composite structural board according to claim 4, wherein:
the filler material includes fibrous fillers.

6. The polymer-based composite structural board according to claim 3, wherein:
the polymer-based composite structural board has a compressive strength of at least 25 psi, a flexural strength (MOR) of at least 400 psi, a flexural strength (load at yield) of at least 20 lbf, and a fastener pull through strength of at least 20 lbf.

7. The polymer-based composite structural board according to claim 6, wherein:
the polymer-based composite structural board has a water absorption rate of 4% by volume or less.

8. The polymer-based composite structural board according to claim 3, wherein:
the polyisocyanurate material is a polyisocyanurate foam material.

9. The polymer-based composite structural board according to claim 8, wherein:
the predominantly polymer foam material core layer contains between 1% and 40% by weight inorganic and/or organic filler material.

10. The polymer-based composite structural board according to claim 9, wherein:
the filler material includes fibrous fillers.

11. The polymer-based composite structural board according to claim 8, wherein:
the polymer-based composite structural board has a compressive strength of at least 25 psi, a flexural strength (MOR) of at least 400 psi, a flexural strength (load at yield) of at least 20 lbf, and a fastener pull through strength of at least 20 lbf.

12. The polymer-based composite structural board according to claim 11, wherein:
the polymer-based composite structural board has a water absorption rate of 4% by volume or less.

13. A foundation wall system of a building structure, comprising:
a concrete foundation wall having an interior side and an exterior side; a plurality of polymer-based composite structural boards overlaying and secured to the interior side of the concrete foundation wall and forming an interior sheathing layer of the foundation wall system; a plurality of polymer-based composite structural boards overlaying and secured to the exterior side of the concrete foundation wall and forming an exterior sheathing layer of the foundation wall system that is in ground contact; each of the polymer-based composite structural boards having a polymer material or predominantly polymer material core layer with a density between 1.6 lbs/ft³ and 25 lbs/ft³; the core layer of each of the polymer-based composite structural boards having a length, a width, and a thickness; and the core layer of each of the polymer-based composite structural boards having a first major surface and a second major surface that are each defined by the length and the width of the core layer with at least one of the major surfaces being overlaid by a facer that is generally coextensive with and bonded to the overlaid major surface.

14. The foundation wall system of a building structure according to claim 13, wherein:
the first major surface and the second major surface of each of the polymer-based composite structural boards are each overlaid by a facer that is generally coextensive with and bonded to the overlaid major surface.

15. The foundation wall system of a building structure according to claim 14, wherein:
the facers are alkali resistant facers.

16. The foundation wall system of a building structure according to claim 14, wherein:
the alkali resistant facers are mineral coated nonwoven fiberglass mats or fiberglass scrim.

17. The foundation wall system of a building structure according to claim 13, wherein:
the thickness of the core layer of each of the polymer-based composite structural boards is between about 0.25 inches and about 2.5 inches; and the core layer of each of the polymer-based composite structural boards is a polyisocyanurate polymer material or predominantly polyisocyanurate polymer material core layer.

18. The foundation wall system of a building structure according to claim 17, wherein:
the core layer of each of the polymer-based composite structural boards is a predominantly polyisocyanurate polymer material core layer that contains between 1% and 40% by weight inorganic and/or organic filler material.

19. The foundation wall system of a building structure according to claim 17, wherein:
each of the polymer-based composite structural boards has a compressive strength of at least 25 psi, a flexural strength (MOR) of at least 400 psi, a flexural strength (load at yield) of at least 20 lbf, and a fastener pull through strength of at least 20 lbf.

20. The foundation wall system of a building structure according to claim 17, wherein:
each of the polymer-based composite structural boards has a water absorption rate of 4% by volume or less.

21. The foundation wall system of a building structure according to claim 13, wherein:
the thickness of the core layer of each of the polymer-based composite structural boards is between about 0.15 inches and about 2.5 inches; and the core layer of each of the polymer-based composite structural boards is a predominantly polyisocyanurate polymer material foam core layer.

22. The foundation wall system of a building structure according to claim 21, wherein:
the foam core layer of each of the polymer-based composite structural boards contains between 1% and 40% by weight inorganic and/or organic filler material.

24. The foundation wall system of a building structure according to claim 21, wherein:
each of the polymer-based composite structural boards has a compressive strength of at least 25 psi, a flexural strength (MOR) of at least 400 psi, a flexural strength (load at yield) of at least 20 lbf, and a fastener pull through strength of at least 20 lbf.

25. The foundation wall system of a building structure according to claim 21, wherein:
each of the polymer-based composite structural boards has a water absorption rate of 4% by volume or less.

26. A utility conduit section for housing utilities, comprising:
a utility conduit section having a generally rectangular in transverse cross section with a top wall, sidewalls, and a bottom wall that are constructed from polymer-based composite structural boards; each of the polymer-based composite structural boards having a polymer material or predominantly polymer material core layer with a density between 1.6 lbs/ft³ and 25 lbs/ft³; the core layer of each of the polymer-based composite structural boards having a length, a width, and a thickness; and the core layer of each of the polymer-based composite structural boards having a first major surface and a second major surface that are each defined by the length and the width of the core layer with at least one of the major surfaces being overlaid by a facer that is generally coextensive with and bonded to the overlaid major surface.

27. The utility conduit section according to claim 26, wherein:
the first major surface and the second major surface of each of the polymer-based composite structural boards are each overlaid by a facer that is generally coextensive with and bonded to the overlaid major surface.

28. The utility conduit section according to claim 27, wherein:
the facers are coated or uncoated nonwoven fiberglass mats or fiberglass scrim.

29. The utility conduit section according to claim 26, wherein:
the thickness of the core layer of each of the polymer-based composite structural boards is between about 0.15 inches and about 2.5 inches; and the core layer of each of the polymer-based composite structural boards is a polyisocyanurate polymer material or predominantly polyisocyanurate polymer material core layer.

30. The utility conduit section according to claim 29, wherein:
the core layer of each of the polymer-based composite structural boards is a predominantly polyisocyanurate polymer material core layer that contains between 1% and 40% by weight inorganic and/or organic filler material.

31. The utility conduit section according to claim 29, wherein:
each of the polymer-based composite structural boards has a compressive strength of at least 25 psi, a flexural strength (MOR) of at least 400 psi, a flexural strength (load at yield) of at least 20 lbf, and a fastener pull through strength of at least 20 lbf.

32. The utility conduit section according to claim 29, wherein:
each of the polymer-based composite structural boards has a water absorption rate of 4% by volume or less.
